(19) United States
(12) Patent Application Publication
(10) Pub. No.: US 2024/0405970 A1
(43) Pub. Date: Dec. 5, 2024

(54) ENCRYPTION SYSTEM FOR A CONSTRAINED ENVIRONMENT

(71) Applicant: NORTHROP GRUMMAN SYSTEMS CORPORATION, FALLS CHURCH, VA (US)

(72) Inventors: MICHAEL CHARLES HINCKLEY, LANCASTER, CA (US); ALEX BARRON, Coeur d’Alene, ID (US); BRIAN CARL TAGG, Poway, CA (US); JOHN SANDERS, RAMONA, CA (US); MARTIN ALEJANDRO NORIEGA SALCEDO, RIVERSIDE, CA (US)

(21) Appl. No.: 18/393,359

(22) Filed: Dec. 21, 2023

Related U.S. Application Data
(60) Provisional application No. 63/505,618, filed on Jun. 1, 2023.

(51) Int. Cl. H04L 9/06; G06K 19/07

(52) U.S. Cl. CPC H04L 9/0631; G06K 19/0723; H04L 2209/12; H04L 2209/24

(57) ABSTRACT

One example includes a security device system. The system includes a constrained environment housing and operational components configured to implement a security function. The system further includes an integrated circuit (IC) configured to implement a 256-bit Advanced Encryption Standard (AES-256) encryption algorithm, the IC comprising fewer than 5,000 gate equivalents and operating at a power of less than 1.5 microwatts to be accommodated in the constrained environment housing.

### RELATED APPLICATIONS

This application claims priority from U.S. Patent Application Ser. No. 63/505,618, filed 1 Jun. 2023, which is incorporated herein by reference in its entirety.

### TECHNICAL FIELD

The present invention relates generally to encryption systems, and specifically to an encryption system for a constrained environment.

### BACKGROUND

Encryption technology has existed for hundreds of years to encode information in documents to obfuscate the content of such encoded documents from adverse parties. In more recent decades, wireless and computer data is encoded by encryption methods to prohibit access to wireless communications and software files by adverse parties. One such manner of encryption is defined in a number of encryption standards, such as Advanced Encryption Standard (AES) as detailed in Federal Information Processing Standards (FIPS) Publication 197. The AES encryption methodology describes a number of different encryption methodologies that provide increasingly greater encryption capability based on having increasingly longer key lengths (e.g., AES-256 over AES-192, and AES-192 over AES-128). As encryption technology has advanced, more complicated encryption may be required to provide for greater security to mitigate decryption by adverse parties. However, the circuitry required for more advanced encryption algorithms can be more complicated, can be larger in size, and can require more power than simpler encryption algorithms.

### SUMMARY

One example includes a security device system. The system includes a constrained environment housing and operational components configured to implement a security function. The system further includes an integrated circuit (IC) configured to implement a 256-bit Advanced Encryption Standard (AES-256) encryption algorithm, the IC comprising fewer than 5,000 gate equivalents and operating at a power of less than 1.5 microwatts to be accommodated in the constrained environment housing.

Another example includes a non-transitory computer readable medium comprising machine-readable instructions. The machine-readable instructions can be executed to generate a State module in a hardware description language (HDL) code. The State module can be configured to store an encryption state. The instructions can also be executed to generate a RoundKey module in the HDL code. The RoundKey module can be configured to store an original encryption key for a 256-bit Advanced Encryption Standard (AES-256) encryption algorithm. The instructions can also be executed to generate a KeyExpansion module in the HDL code. The KeyExpansion module can be configured to implement an iterative key expansion operation in which the original encryption key is expanded to generate an encryption subkey of a key schedule in each of a plurality of iterations having a quantity defined by the AES-256 encryption algorithm. The instructions can also be executed to generate an AddRoundKey module in the HDL code. The AddRoundKey module can be configured to combine an encryption round key corresponding to one of the original encryption key and the encryption subkey of one of the iterations with the encryption state to modify the encryption state in each of the iterations. The instructions can further be executed to synthesize the HDL code to generate an integrated circuit (IC) design based on the HDL code, and to fabricate an IC based on the HDL code.

Another example includes a radio frequency identification (RFID) tag system. The system includes a transponder configured to wirelessly communicate with an RFID reader via wireless signals and a memory configured to store sensitive data. The system further includes an integrated circuit (IC) configured to implement a 256-bit Advanced Encryption Standard (AES-256) encryption algorithm configured to encrypt the sensitive data.

### BRIEF DESCRIPTION OF THE DRAWINGS

FIG. 1 illustrates an example block diagram of a security device.

FIG. 2 illustrates an example block diagram of an AES encryption algorithm.

FIG. 3 illustrates an example block diagram of a MixColumn module.

FIG. 4 illustrates an example block diagram of a key expansion system.

FIG. 5 illustrates an example block diagram of AES encryption algorithm modules.

FIG. 6 illustrates an example diagram of a radio frequency identification (RFID) system.

FIG. 7 illustrates an example of a method for fabricating an integrated circuit (IC).

### DETAILED DESCRIPTION

The present invention relates generally to encryption systems, and specifically to an encryption system for a constrained environment. The encryption system described herein can correspond to a 256-bit Advanced Encryption Standard (AES-256) encryption algorithm that operates in compliance with the Federal Information Processing Standards Publication 197 AES (FIPS PUB 197). The AES-256 encryption algorithm can be implemented on an integrated circuit (IC), such as an application specific integrated circuit (ASIC) or field-programmable gate array (FPGA) in a constrained environment. As described herein, the term “constrained environment” refers to an environment that can accommodate the IC in a limited three-dimensional space and/or with limited power. For example, the design of the AES-256 encryption algorithm can be implemented (e.g., in Verilog) and synthesized (e.g., in Synplify Pro S-2021.09 for a Xilinx Spartan7 XC7S25 FPGA) to provide a circuit that occupies 820 lookup tables (LUTs). As is known in the art, a single LUT can be equivalent to a quantity of six two-input NAND gates. Therefore, the synthesis for an ASIC that implements the AES-256 encryption algorithm described herein results in a circuit that is less than approximately 5,000 gate equivalents (GEs), which can consume approximately a single microwatt (u W) of power. Therefore, as described herein, the IC on which the AES-256 encryption algorithm operates can be fabricated to have fewer than approximately 5,000 GEs and can consume less than 1.5 u W of power to be able to be accommodated in the constrained environment described herein, while still operating in compliance with FIPS PUB 197.

As an example, the security device described herein that can accommodate the IC that implements the AES-256 encryption algorithm in a constrained environment can be a radio frequency identification (RFID) tag. However, other examples of a constrained environment can include a wireless device that implements a Wi-Fi Protected Access 3 (WPA3) security protocol that may require the AES-256 encryption algorithm, Edge Computing and/or Security Networking that may require the AES-256 encryption algorithm, Near-field Communication (NFC) devices that may be designed in a small and power efficient form-factor, compact application of Internet of Things (IoT), or any of a variety of other devices that may be require a small form-factor design and/or a very low power consumption.

The IC can be fabricated from a hardware description language (HDL) code, such as Verilog. The IC can be designed based on inputs to the HDL code, which can then be synthesized to generate the IC design for fabrication using any of a variety of IC fabrication tools. As described herein, the AES-256 encryption algorithm can be implemented based on improvements to the modules therein to achieve significant reduction in the GEs, power consumption, and clock cycles. The reduction in size resulting from the reduction in GEs, as well as the increase in power efficiency and clock cycles can allow for the IC to operate the AES-256 encryption algorithm with improved size, weight, and power (SWaP) over conventional circuits that implement an AES-256 encryption algorithm. Therefore, the IC configured as an ASIC or an FPGA can implement the AES-256 encryption algorithm in a compact form-factor that enables use in the constrained environment (e.g., an RFID tag). As an example, the improvements to the modules can include the use of same circuits for different functions, such as for column mixing of the encryption state and key expansion of the original key, as described in greater detail herein.

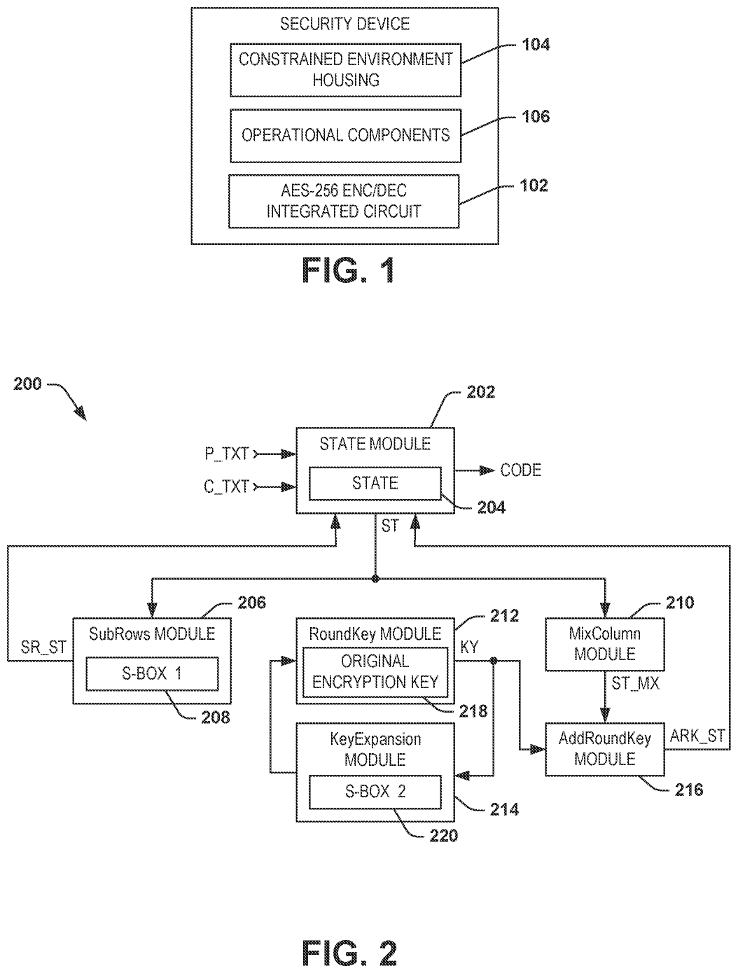

FIG. 1 illustrates an example block diagram of a security device 100. The security device 100 can be any of a variety of electronic devices that can implement an AES-256 encryption algorithm in a constrained environment. In the example of FIG. 1, the security device 100 includes an integrated circuit (IC) 102 (“AES-256 ENC/DEC INTEGRATED CIRCUIT”) that can be configured to operate the AES-256 encryption algorithm for encryption and/or decryption. As an example, the IC 102 can be configured as an application specific integrated circuit (ASIC) or a field-programmable gate array (FPGA). As an example, the IC 102 can be fabricated from a hardware description language (HDL) code, such as Verilog. The IC 102 can be designed based on inputs to the HDL code that correspond to modules of the AES-256 encryption algorithm. The HDL code can be synthesized to generate the IC design for fabrication of the IC 102 using any of a variety of IC fabrication tools. The security device 100 can also include a constrained environment housing 104 that can define spatial or power consumption limitations.

To be accommodated in the constrained environment housing 104, the IC 102 can be fabricated to have fewer than approximately 5,000 gate equivalents (GEs) and can consume less than 1.5 μW of power while still being able to implement the AES-256 encryption algorithm. For example, some highly secure locations or applications may require a greater level of security encryption/decryption than is possible with other encryption algorithms, such as AES-128 or AES-192. Such lesser encryption algorithms that have a more limited level of security capability may be able to be accommodated in smaller convenient packages. However, to achieve sufficient security requirements, more applications require the more complex encryption/decryption capability of the AES-256 encryption algorithm, which is typically operated on a large circuit and with greater power consumption to be able to accommodate the significantly greater processing that is required for implementing the AES-256 encryption algorithm. However, as described herein, the IC 102 can be designed to operate the AES-256 encryption algorithm in a constrained environment, unlike conventional AES-256 encryption algorithm circuits, and thus within the constrained environment housing 104.

In the example of FIG. 1, the security device 100 includes operational components 106 that are configured to implement a security function. The operational components 106 can correspond to any of a variety of circuit devices, components, or features that facilitate use of the security device 100 to perform the security function. As an example, the security device 100 can be configured as a radio frequency identification (RFID) tag that is configured to encrypt/decrypt data. Therefore, in the example of an RFID tag, the operational components 106 can include a transponder, a memory, and/or a variety of other components.

FIG. 2 illustrates an example block diagram of an AES encryption algorithm 200. The AES-256 encryption algorithm 200 is demonstrated diagrammatically as blocks corresponding to specific programmed modules of the AES-256 encryption algorithm 200. Therefore, the AES-256 encryption algorithm 200 is demonstrated in the example of FIG. 2 as a set of software/firmware modules that are defined by functionality in the AES-256 encryption algorithm 200. The AES-256 encryption algorithm 200 can correspond to the AES-256 encryption algorithm that operates on the IC 102 in the example of FIG. 1. Therefore, reference is to be made to the example of FIG. 1 in the following description of the example of FIG. 2.

The AES-256 encryption algorithm 200 includes a State module 202 that is configured to store an encryption state 204. The encryption state 204 can initially be provided as an input to the State module 202 as either a plaintext input (“P_TXT”) for encryption or a ciphertext input (“C_TXT”) for decryption. The encryption state 204 is thus modified responsive to operation of the AES-256 encryption algorithm 200 and output from the State module 202, and thus from the corresponding IC 102, as a signal CODE. As described herein, the term “signal”, as applied to the communication to, from, or between modules of the AES-256 encryption algorithm 200, can refer to a set of bits in a register. Thus, the set of bits in a register corresponding to a “signal” are provided from a register or accessed by another register via the modules of the AES-256 encryption algorithm 200. The modified encryption state 204 can thus be output as the signal CODE corresponding to a ciphertext code in response to an encryption procedure, or to a plaintext code in response to a decryption procedure. As an example, the State module 202 can be implemented as a 128-bit register that stores the encryption state 204. The register can be arranged in a matrix of four rows and four columns of bytes, such as defined by the Federal Information Processing Standards (FIPS) Publication 197.

The encryption state 204 is accessed from the State module 202, demonstrated as a signal ST, by a SubRows module 206. The SubRows module 206 is demonstrated in the example of FIG. 2 as including a first S-box 208. The first S-Box 208 can be configured as any of a variety of different types of Rijndael S-Boxes that provides an 8-bit S-Box transformation, such as the Canright S-Box. Thus, the first S-Box 208 can be configured in a most efficient and compact manner. The SubRows module 206 is configured to implement the dual operation of a SubBytes operation and a ShiftRows operation to the encryption state 204. As an example, a SubBytes operation applies an S-Box transformation of an encryption state for an encryption procedure, and applies an inverse S-Box transformation of an encryption state for a decryption procedure. As another example, a ShiftRows operation shifts the bytes of each row of an encryption state right for encryption or left for decryption by a number of bytes equal to the index of the respective row.

By combining the operations of the SubBytes and ShiftRows operations, the SubRows module 206 applies an S-Box transformation to each byte of the encryption state 204 via the first S-Box 208 and shifts the respective transformed byte a number of bytes based on the row index. As described herein, the first S-Box 208 includes both forward operation circuitry for an encryption procedure and inverse operation circuitry for a decryption procedure. The SubRows module 206 can thus output a modified encryption state, demonstrated in the example of FIG. 2 as a signal SR_ST, that is the result of the SubRows operation (e.g., the combined SubBytes and ShiftRows operations) at each iteration of AddRoundKey, as described in greater detail herein. The modified encryption state SR_ST is thus provided back to the State module 202 to be stored as the next encryption state 204.

The encryption state 204 (e.g., the next encryption state corresponding to the modified encryption state SR_ST) is also accessed from the State module 202, demonstrated as the signal ST, by a MixColumn module 210. The MixColumn module 210 is configured to perform a mathematical transformation of each column of the encryption state 204. The mathematical transformation can be implemented in a MixColumn operation for encryption and in an inverse MixColumn operation for decryption. The MixColumn operation and inverse MixColumn operation are implemented as bit-wise shifts of the column(s) of the encryption state in combination with exclusive-OR (XOR) logic operations. For example, the MixColumn operation can be performed as a Galois Field (GF) matrix multiplication (e.g., GF (28)) with a given one of the columns of the encryption state 204 in a given iteration. At each iteration, the MixColumn module 210 outputs the transformed encryption state, demonstrated as a signal ST_MX. As described in greater detail herein, the MixColumn module 210 can be programmed in the HDL code to provide for a significant reduction in complexity, and therefore a significant reduction in GEs.

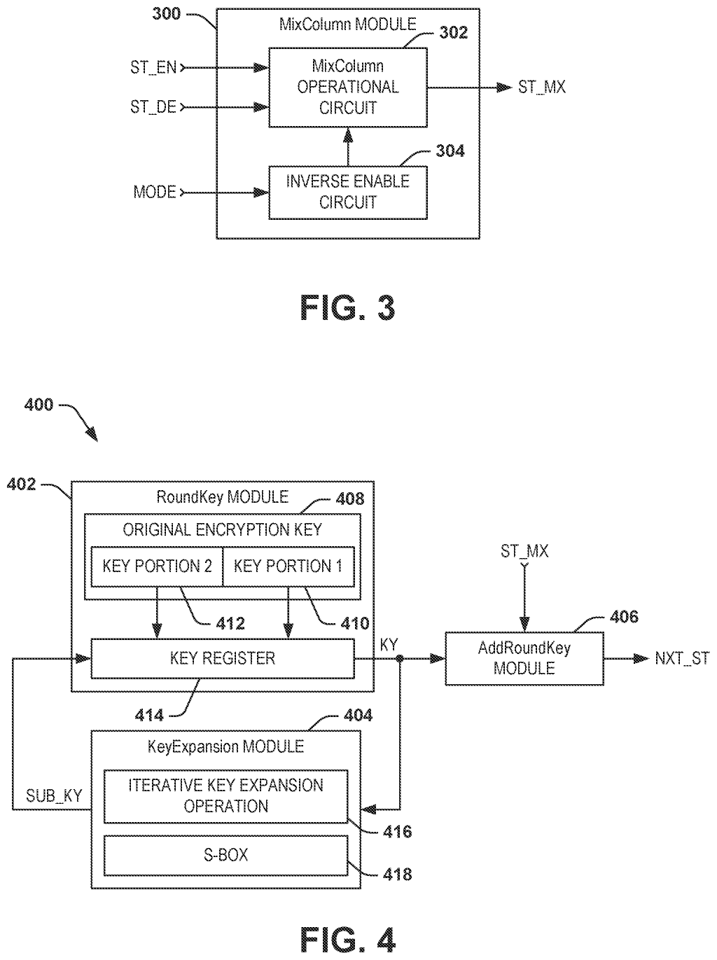

FIG. 3 illustrates an example block diagram of a MixColumn module 300. The MixColumn module 300 can correspond to the MixColumn module 210 in the example of FIG. 2. Therefore, reference is to be made to the example of FIG. 2 in the following description of the example of FIG. 3.

The MixColumn module 300 includes a MixColumn operational circuit 302 and an inverse enable circuit 304. The MixColumn operational circuit 302 is demonstrated as receiving the encryption state (e.g., the encryption state 204) in an encryption procedure, demonstrated as a signal ST_EN, or in a decryption procedure, demonstrated as a signal ST_DE. The MixColumn operational circuit 302 is demonstrated as providing the transformed encryption state ST_MX as an output. Therefore, the MixColumn operational circuit 302 is configured to provide the MixColumn operation on the encryption state 204 as either the state ST_EN for an encryption procedure or the state ST_DE in a decryption procedure. Therefore, the MixColumn operational circuit 302 provides the same MixColumn function for both encryption and decryption. In other words, the same circuit (e.g., the MixColumn operational circuit 302) is used for the encryption state 204 in both encryption and decryption procedures, as opposed to two separate dedicated circuits for the encryption procedure and the decryption procedure, respectively.

The inverse enable circuit 304 is demonstrated as receiving a mode input MODE that can correspond to a toggle between the encryption and decryption procedures. The inverse enable circuit 304 can thus operate in cooperation with the MixColumn operational circuit 302 to provide the MixColumn operation for a decryption procedure using the same circuitry that is used for an encryption procedure. The inverse enable circuit 304 can be configured as only a small addition to the complexity of the MixColumn module 300, and thus provides only a nominal addition to the GEs of the MixColumn operational circuit 302. With the addition of the inverse enable circuit 304, by implementing the MixColumn operational circuit 302 as a single circuit for both encryption and decryption procedures, as opposed to two separate dedicated circuits for encryption and decryption procedures, respectively, the MixColumn module 300 can be significantly more simplified, and thus arranged in a much more compact manner (e.g., with fewer GEs) than a typical MixColumn module in a conventional AES-256 encryption algorithm.

As described above, the encryption state 204 can be expressed as a four row and four column matrix, demonstrated by:

$$[ \begin{matrix}{S}_{0 , 0} & {S}_{0 , 1} & {S}_{0 , 2} & {S}_{0 , 3} \\ {S}_{1 , 0} & {S}_{1 , 1} & {S}_{1 , 2} & {S}_{1 , 3} \\ {S}_{2 , 0} & {S}_{2 , 1} & {S}_{2 , 2} & {S}_{2 , 3} \\ {S}_{3 , 0} & {S}_{3 , 1} & {S}_{3 , 2} & {S}_{3 , 3}\end{matrix} ] \qquad Equation 1$$

As described above, the MixColumn operation can be performed as a GF (28) matrix multiplication with a given one of the columns of the encryption state 204 in a given iteration, as demonstrated by:

$$[ \begin{matrix}{S}_{0 , C}^{′} \\ {S}_{1 , C}^{′} \\ {S}_{2 , C}^{′} \\ {S}_{3 , C}^{′}\end{matrix} ] = [ \begin{matrix}02 & 03 & 01 & 01 \\ 01 & 02 & 03 & 01 \\ 01 & 01 & 02 & 03 \\ 03 & 01 & 01 & 02\end{matrix} ] [ \begin{matrix}{S}_{0 , C} \\ {S}_{1 , C} \\ {S}_{2 , C} \\ {S}_{3 , C}\end{matrix} ] \qquad Equation 2$$

The matrix multiplication for an inverse MixColumn operation, as provided during a decryption procedure, can be expressed in a similar manner. For example, the inverse MixColumn operation can also be performed as a GF (28) matrix multiplication with a given one of the columns of the encryption state 204 in a given iteration, as demonstrated by:

$$[ \begin{matrix}{S}_{0 , C}^{′} \\ {S}_{1 , C}^{′} \\ {S}_{2 , C}^{′} \\ {S}_{3 , C}^{′}\end{matrix} ] = [ \begin{matrix}0 B & 0 B & 0 D & 09 \\ 09 & 0 E & 0 B & 0 D \\ 0 D & 09 & 0 E & 0 B \\ 0 B & 0 D & 09 & 0 E\end{matrix} ] [ \begin{matrix}{S}_{0 , C} \\ {S}_{1 , C} \\ {S}_{2 , C} \\ {S}_{3 , C}\end{matrix} ] \qquad Equation 3$$

As described above, the MixColumn operational circuit 302 can be implemented as the same circuit for the encryption state 204 in both encryption and decryption procedures. To accomplish the use of a single MixColumn operational circuit 302 for both encryption and decryption procedures, the matrix multiplication of Equation 2 can be factored into a GF (28) matrix multiplication of a matrix with the given one of the columns of the encryption state 204 in a given iteration, as follows:

$$[ \begin{matrix}{S}_{0 , C}^{′} \\ {S}_{1 , C}^{′} \\ {S}_{2 , C}^{′} \\ {S}_{3 , C}^{′}\end{matrix} ] = [ \begin{matrix}0 B & 0 B & 0 D & 09 \\ 09 & 0 E & 0 B & 0 D \\ 0 D & 09 & 0 E & 0 B \\ 0 B & 0 D & 09 & 0 E\end{matrix} ] [ \begin{matrix}05 & 00 & 04 & 00 \\ 00 & 05 & 00 & 04 \\ 04 & 00 & 05 & 00 \\ 00 & 04 & 00 & 05\end{matrix} ] [ \begin{matrix}{S}_{0 , C} \\ {S}_{1 , C} \\ {S}_{2 , C} \\ {S}_{3 , C}\end{matrix} ] \qquad Equation 4$$

Therefore, by implementing the inverse MixColumn operation for decryption by using the same MixColumn operational circuit 302 with which the MixColumn operation for encryption is implemented, the complexity of the MixColumn module 300 can be significantly reduced based on the resource sharing between the encryption and decryption procedures. Accordingly, the MixColumn module 300 can have significantly fewer GEs than a typical MixColumn module for a conventional AES-256 encryption algorithm.

Referring back to the example of FIG. 2, the AES-256 encryption algorithm 200 includes a RoundKey module 212, a KeyExpansion module 214, and an AddRoundKey module 216. The RoundKey module 212 is configured to store an original encryption key 218 for the AES-256 encryption algorithm 200. As an example, the original encryption key 218 can be received by the IC 102 from an external device (e.g., that also provides the data to be encrypted/decrypted) or can be saved in a memory on the associated security device (e.g., security device 100). The original encryption key 218 can be a 256-bit (32-byte) encryption key, as required by the FIPS-197 standard that defines the AES-256 encryption algorithm. As described in greater detail herein, the RoundKey module 212 also includes a key register that is configured to store at least one encryption round key in each iteration of a key expansion operation. As an example, the key register can be a 32-byte register that can store two encryption round keys at a time. As described herein, the term “encryption round key” can refer to a portion of the original encryption key 218 (e.g., a 128-bit portion of the 256-bit original encryption key 218) or to an encryption subkey (e.g., a 128-bit encryption subkey) of a key schedule that is generated by the key expansion operation.

The RoundKey module 212 provides an encryption round key (e.g., a portion of the original encryption key 218 or an encryption subkey), demonstrated in the example of FIG. 2 as a signal KY, to both the KeyExpansion module 214 and the AddRoundKey module 216. The KeyExpansion module 214 is configured to implement an iterative key expansion operation in which the original encryption key 218 is expanded to generate an encryption subkey of the key schedule in each of a plurality of iterations. In the example of FIG. 2, the KeyExpansion module 214 is demonstrated as including a second S-Box 220 that is implemented for the iterative key expansion operation. The KeyExpansion module 214 thus provides the encryption subkey at each iteration back to the RoundKey module 212 to store the encryption subkey in the key register for access by the AddRoundKey module 216.

The AddRoundKey module 216 is configured to combine the encryption round key KY (e.g., a portion of the original encryption key 218 and/or an encryption subkey) with the transformed encryption state ST_MX. As described above, the original encryption key 218 can be a 256-bit code, such that the original encryption key 218 can includes two 128-bit portions. As an example, each of the encryption subkeys can be a 128-bit code. Therefore, the AddRoundKey module 216 can be configured to combine the 128-bit encryption round key KY with the 128-bit transformed encryption state ST_MX by implementing a bit-wise XOR logic function. The AddRoundKey module 216 can thus output a modified encryption state, demonstrated in the example of FIG. 2 as a signal ARK_ST, that is the result of the bit-wise XOR logic function at each iteration. The modified encryption state NXT_ST is thus provided to the State module 202 to be stored as the next encryption state 204. The next encryption state 204 can thus be provided to the SubRows module 206 as the signal ST to implement the SubRows operation on the next encryption state 204 for a next iteration.

FIG. 4 illustrates an example block diagram of a key expansion system 400. The key expansion system 400 is demonstrated as the aggregation of a RoundKey module 402, a KeyExpansion module 404, and an AddRoundKey module 406. The RoundKey module 402, the KeyExpansion module 404, and the AddRoundKey module 406 can correspond respectively to the RoundKey module 212, the KeyExpansion module 214, and the AddRoundKey module 216, respectively, in the example of FIG. 2. Therefore, reference is to be made to the example of FIG. 2 in the following description of the example of FIG. 4.

The RoundKey module 402 is configured to store the original encryption key 408 that can correspond to a specific dedicated encryption key for the AES-256 encryption algorithm 200. As an example, the original encryption key 408 can be received by the IC 102 from an external device (e.g., that also provides the data to be encrypted/decrypted) or can be saved in a memory on the associated security device (e.g., security device 100). The original encryption key 218 can be a 256-bit, and can be a 256-bit (32-byte) encryption key, as required by the FIPS-197 standard that defines the AES-256 encryption algorithm 200. In the example of FIG. 4, the original encryption key 408 includes a first original key portion 410 and a second original key portion 412. Each of the first and second key portions 410 and 412 can be 128-bit codes that collectively form the original encryption key 408 and correspond to encryption round keys.

The RoundKey module 402 also includes a key register 414 that is configured to store the encryption round keys, such as a pair of the encryption round keys, at a given time. For example, the key register 414 can be a 32-byte register, such that the key register can be configured to store a pair-wise combination of encryption round keys, and thus a pair-wise combination of the first original key portion 410, the second original key portion 412, and at least one encryption subkey of a key schedule (e.g., both of the key portions 410 and 412, one of the key portions 410 or 412 and an encryption subkey, or two encryption subkeys) in each iteration of an iterative key expansion operation 416 in which the original encryption key 408 is expanded to generate an encryption subkey of the key schedule in each of a plurality of iterations.

As an example, as encryption subkeys are written to the key register 414, the encryption round keys that were stored in the key register 414 can be replaced by the newly generated encryption subkeys from the iterative key expansion operation 416 in the key register 414. As an example, one of the previous encryption round keys that are stored in the key register 414 can be overwritten to accommodate storage of the newly generated encryption subkey from the iterative key expansion operation 416. For example, the newly generated encryption subkey in each iteration can overwrite one of the two 128-bit blocks of the key register 414 in which the encryption round keys are stored, such as in an alternating manner, after the respective one of the encryption round keys has already been provided to the AddRoundKey module 406. In this manner, the encryption subkeys that are generated by the KeyExpansion module 404 are overwritten in the key register 414 by newly generated encryption subkeys when the encryption round key in the key register 414 is no longer needed by the key expansion system 400. As a result, the KeyExpansion module 404 can provide the key expansion operation in a much more compact manner than a conventional key expansion operation in which all of the encryption subkeys of a key schedule are generated at once, and are thus all stored in a much larger register before the encryption subkeys are needed and continue to be stored after the encryption subkeys are no longer needed.

The RoundKey module 402 provides an encryption round key (e.g., a portion of the original encryption key 408 and/or an encryption subkey), demonstrated in the example of FIG. 4 as a signal KY, to the KeyExpansion module 404. The KeyExpansion module 404 is configured to implement the iterative key expansion operation 416. The iterative key expansion operation 416 can be configured to generate a first encryption subkey in response to the first original key portion 410 of the original encryption key 408 in the first iteration of the key expansion operation, to generate a second encryption subkey in response to the second original key portion 412 of the original encryption key 408 in the second iteration of the key expansion operation, and to generate each subsequent encryption subkey from the encryption subkey of a preceding iteration. The RoundKey module 402 is also configured to provide an encryption round key KY from the key register 414 to the AddRoundKey module 406 in each iteration, such that the AddRoundKey module 406 generates a modified encryption state ARK_ST in each iteration. As an example, the iterative key expansion operation 416 can include a total of fourteen iterations for the key expansion system 400 to provide fifteen modified encryption states ARK_ST, as defined in the FIPS-197 standard.

In the example of FIG. 4, the KeyExpansion module 404 includes an S-Box 418 that is implemented to provide S-box transformations for the iterative key expansion operation 416. The S-box 418 can correspond to the second S-Box 220 in the example of FIG. 2, for example. As described in greater detail herein, the S-box 418 can be configured as a forward-only S-Box. The KeyExpansion module 404 thus provides the generated encryption subkey at each iteration to the RoundKey module 402 to store the encryption subkey in the key register 414 for access by the AddRoundKey module 406.

For example, in the first iteration, the RoundKey module 402 provides the first original key portion 410 as the encryption round key KY to the AddRoundKey module 406, and provides the first original key portion 410 as the encryption round key KY to the KeyExpansion module 404. The iterative key expansion operation 416 thus generates a first encryption subkey based on the first original key portion 410. The first encryption subkey is provided to the RoundKey module 402, demonstrated as a signal SUB_KY, to be saved in the key register 414, and thus overwriting the first original key portion 410 in the key register 414.

In the second iteration, the RoundKey module 402 provides the second original key portion 412 as the encryption round key KY to the AddRoundKey module 406, and provides the second original key portion 412 as the encryption round key KY to the KeyExpansion module 404. The iterative key expansion operation 416 thus generates a second encryption subkey based on the second original key portion 412. The second encryption subkey SUB_KY is provided to the RoundKey module 402 to be saved in the key register 414, and thus overwriting the second original key portion 412 in the key register 414.

In the third iteration, the RoundKey module 402 provides the first encryption subkey as the encryption round key KY to the AddRoundKey module 406, and provides the first encryption subkey as the encryption round key KY to the KeyExpansion module 404. The iterative key expansion operation 416 thus generates a third encryption subkey based on the first encryption subkey. The third encryption subkey SUB_KY is provided to the RoundKey module 402 to be saved in the key register 414, and thus overwriting the first encryption subkey in the key register 414. The key expansion operation continues in this manner for each of the remaining twelve iterations, for fifteen total iterations, with the encryption round key KY being provided to the AddRoundKey module 406 in each iteration.

Therefore, as described in the example of FIG. 4, the KeyExpansion module 404 can be configured significantly more efficiently than a conventional KeyExpansion module of a typical AES-256 encryption algorithm. Particularly, a conventional KeyExpansion module is configured to generate an entire key schedule at a single instance. Thus, the conventional KeyExpansion module requires 240-bytes to store the entirety of the key schedule (two 16-byte portions of the original encryption key plus thirteen 16-byte encryption subkeys). Thus, all of the encryption subkeys are stored in the 240-bytes of registers both before the encryption subkeys of the key schedule are provided to the associated AddRoundKey module, and thus before the encryption subkeys are needed, and after the encryption subkeys of the key schedule have already been provided to the associated AddRoundKey module, and thus after the encryption subkeys are no longer needed. Accordingly, the conventional KeyExpansion module requires multiple registers to concurrently store the entirety of the key schedule.

However, as described above, because the RoundKey module 402 only provides a single round key at a time to the KeyExpansion module 404 and the AddRoundKey module 406, the iterative key expansion operation 416 only generates new encryption subkeys of the key schedule when the encryption subkeys are needed to be applied to the KeyExpansion module 404 and the AddRoundKey module 406. Thus, the RoundKey module 402 can overwrite the encryption round keys in the key register 414 that are no longer needed by the KeyExpansion module 404 and the AddRoundKey module 406. In this manner, the key register 414 can be fabricated as being an only 32-byte register in length while still allowing a full key schedule to be iteratively generated and provided to the KeyExpansion module 404 and the AddRoundKey module 406 by the iterative key expansion operation 416. Therefore, as opposed to a conventional KeyExpansion module that requires 240-bytes of registers to hold an entire key schedule that is generated at a single instance instead of iteratively generated, the KeyExpansion module 404 can be fabricated as having significantly fewer GEs and significantly less power consumption than a conventional KeyExpansion module.

At the conclusion of the iterative key expansion operation 416, the final two encryption subkeys of the key schedule are stored in the key register 414. Therefore, during a subsequent decryption procedure, the RoundKey module 402 can start by providing the last encryption subkey of the key schedule to the KeyExpansion module 404 and the AddRoundKey module 406, such that the AddRoundKey module 406 can combine the last encryption subkey to the modified encryption state ST_MX to generate the next modified encryption state NXT_ST. The KeyExpansion module 404 can thus generate previous encryption subkeys via the iterative key expansion operation 416 in reverse order of the key schedule. In the last two iterations of the reverse iterative key expansion operation during the decryption procedure, the RoundKey module 402 can provide the original encryption key 408 to the AddRoundKey module 406 (e.g., in reverse order of the second original key portion 412 followed by the first original key portion 410) to complete the decryption procedure. Accordingly, the RoundKey module 402 and the KeyExpansion module 404 can operate in the same efficient manner for the decryption procedure, using only the 32-byte key register 414 and iterative generation of encryption subkeys as needed, as provided in the encryption procedure. (*** INVENTORS, HOW IS THE KEY EXPANSION OPERATION REVERSED IN A DECRYPTION PROCEDURE IF THERE IS NO INVERSE OPERATION OF THE S-BOX IN THE KEYEXPANSION MODULE?***)

The AddRoundKey module 406 is configured to combine the encryption round key KY with the transformed encryption state ST_MX in each iteration. As described above, each of the encryption round keys (e.g., the first and second original key portions 410 and 412 and the encryption subkeys) can be arranged as 128-bit codes. Therefore, the AddRoundKey module 406 can be configured to combine the 128-bit encryption round key KY with the 128-bit transformed encryption state ST_MX by implementing a bit-wise XOR logic function. The AddRoundKey module 406 can thus output a modified encryption state, demonstrated in the example of FIG. 4 as a signal NXT_ST, that is the result of the bit-wise XOR logic function at each iteration. The modified encryption state NXT_ST is thus provided to the State module 202 to be stored as the next encryption state 204. The next encryption state 204 can thus be provided to the SubRows module 206 as the signal ST to implement the SubRows operation on the next encryption state 204 for a next iteration.

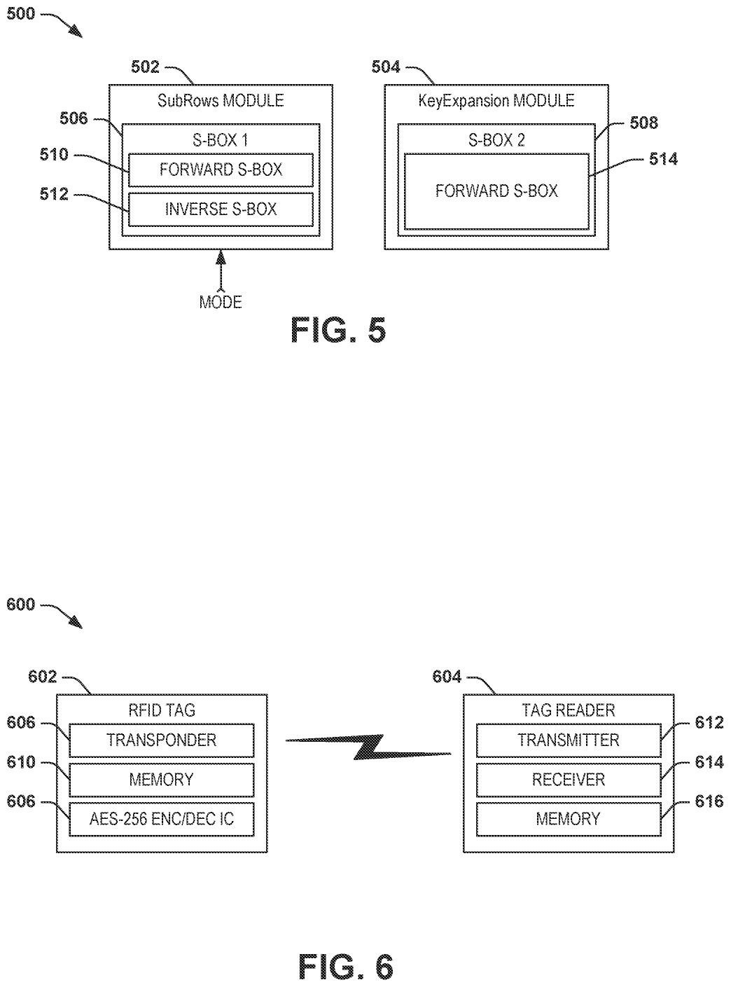

FIG. 5 illustrates an example block diagram 500 of AES encryption algorithm modules. The diagram 500 includes a SubRows module 502 and a KeyExpansion module 504. The SubRows module 502 and the KeyExpansion module 504 can correspond, respectively, to the SubRows module 206 and the KeyExpansion module 214 in the example of FIG. 2. Therefore, reference is to be made to the example of FIG. 2 in the following description of the example of FIG. 5.

The SubRows module 502 includes a first S-Box 506 and the KeyExpansion module 504 includes a second S-Box 508. As an example, both the first and second S-Boxes can be configured as of any of a variety of different types of Rijndael S-Boxes that provides an 8-bit S-Box transformation, such as the Canright S-Box. The first and second S-Boxes 506 and 508 can be configured to operate concurrently during implementation of the AES-256 encryption algorithm. For example, while the SubRows module 502 is performing the SubRows operation via the first S-Box 506 on a modified version of the encryption state 204, the KeyExpansion module 504 can be performing the iterative key expansion operation to generate a next encryption subkey via the second S-Box 508. Concurrent operation of the first and second S-Boxes 506 and 508 provides for a more efficient implementation of the AES-256 encryption algorithm 200.

In the example of FIG. 5, the first S-Box 506 includes a forward operation circuit (“FORWARD OPERATION”) 510 and an inverse operation circuit (“INVERSE OPERATION”) 512. Therefore, the forward operation circuit 510 is configured to operate to provide the S-Box transformation in the SubRows operation (e.g., the SubBytes sub-operation) for an encryption procedure, and the inverse operation circuit 512 is configured to operate to provide the S-Box transformation in the SubRows operation (e.g., the SubBytes sub-operation) for a decryption procedure. In the example of FIG. 5, the SubRows module 502 is configured to receive the mode input MODE that can correspond to the toggle between the encryption and decryption procedures.

In the example of FIG. 5, the second S-Box 508 includes a forward operation circuit (“FORWARD OPERATION”) 514 only. The forward operation circuit 514 is configured to operate to provide the S-Box transformation for the key expansion operation to generate each of the encryption subkeys based on a respective preceding encryption subkey. In a typical AES-256 encryption algorithm, providing a second S-Box for a KeyExpansion module can be very efficiently accomplished by merely copying a first S-Box for an associated SubBytes module. By copying a first S-Box for an associated SubBytes module to provide a second S-Box for the KeyExpansion module, the second S-Box would necessarily include an inverse operation circuit.

However, the KeyExpansion operation implements only forward operation, and thus does not require an inverse operation circuit. Therefore, by providing the second S-Box 508 to include only a forward operation circuit 514, and to not include an inverse operation circuit, the second S-Box 508 can be provided as a significantly more efficient circuit, as opposed to a KeyExpansion S-Box that is merely a copy of the SubBytes S-Box in a conventional AES-256 encryption algorithm. As a result, the quantity of GEs can be decreased in the circuit design, and the operational power consumption of the second S-Box 508 can be decreased relative to the first S-Box 506. Accordingly, providing the second S-Box 508 to include only a forward operation circuit 514 can contribute to accommodating the IC 102 on which the AES-256 encryption algorithm 200 operates in the constrained environment.

FIG. 6 illustrates an example diagram of a radio frequency identification (RFID) system 600. The RFID system 600 includes an RFID tag 602 and a tag reader 604 that can be wirelessly communicatively coupled. The RFID tag 602 includes an IC 606 (“AES-256 ENC/DEC IC”) that is configured to implement an AES-256 encryption algorithm. As an example, the IC 606 can be configured as one of an ASIC or an FPGA that is designed and fabricated to implement the AES-256 encryption algorithm 200. Therefore, reference is to be made to the example of FIGS. 2-5 in the following description of the example of FIG. 6.

The RFID tag 602 also includes a transponder 608 and a memory 610. The tag reader 604 includes a transmitter 612 and a receiver 614 (e.g., parts of a transceiver device), and also includes a memory 616. As an example, the transmitter 612 can be configured to emit an RF signal that is received by the transponder 608. The transponder 608 can thus receive the RF signal and transmit an RF response signal. The RF signal and RF response signal are demonstrated generally at 618. For example, the memory 610 can be configured to store encrypted sensitive data. As another example, the memory 610 can be configured to store an original encryption key (e.g., the original encryption key 408).

The RFID system 600 can be implemented for an encryption procedure or a decryption procedure via the AES-256 encryption algorithm 200. In an encryption procedure, the transmitter 612 can be configured to provide an encryption request that includes sensitive data to the RFID tag 602 via the RF signal. As an example, the RF signal can also include an original encryption key (e.g., saved in the memory 616) that is transmitted from the tag reader 604 to the RFID tag 602. In the example of the RF signal including the original encryption key, the memory 616 can also include a database that associates encryption keys (e.g., including the original encryption key) with RFID tag information (e.g., including the RFID tag 602). Alternatively, the original encryption key can be stored in the memory 610. The transponder 608 can receive the RF signal and can encrypt the sensitive data via the AES-256 encryption algorithm operating on the IC 606. The encrypted sensitive data can be stored in the memory 610 and/or can be transmitted back to the tag reader 604 via the RF response signal provided by the transponder 608, such that the receiver 614 can receive the RF response signal and save the encrypted sensitive data in the memory 616.

In a decryption procedure, the transmitter 612 can be configured to provide a decryption request that includes sensitive data to the RFID tag 602 via the RF signal. As an example, the RF signal can also include an original encryption key (e.g., saved in the memory 616) that is transmitted from the tag reader 604 to the RFID tag 602. In the example of the RF signal including the original encryption key, the memory 616 can also include the key database that associates encryption keys with RFID tag information. Alternatively, the original encryption key can be stored in the memory 610. The transponder 608 can receive the RF signal and can decrypt the sensitive data via the AES-256 encryption algorithm operating on the IC 606. The decrypted sensitive data can be transmitted back to the tag reader 604 via the RF response signal provided by the transponder 608, such that the receiver 614 can receive the RF response signal and save the decrypted sensitive data in the memory 616.

As described above, the AES-256 encryption algorithm 200 can provide a significantly greater encryption security than other encryption/decryption algorithms (e.g., AES-128 or AES-192). Therefore, the RFID system 600 can be implemented in a very high level security environment in which the level of security provided by the AES-256 encryption algorithm 200 is required. As also described above, the AES-256 encryption algorithm 200 can be designed to be spatially efficient with minimal power consumption. Therefore, the IC 606 on which the AES-256 encryption algorithm 200 is implemented can be provided in the constrained environment housing that is provided by the RFID tag 602, which is otherwise too small and unable to provide sufficient power (e.g., via magnetic flux power transfer) to accommodate a conventional circuit that implements an AES-256 encryption algorithm. Accordingly, by designing the AES-256 encryption algorithm 200 to have less than 5,000 GEs and to consume less than 1.5 microwatts of power, the AES-256 encryption algorithm 200 can be implemented on the IC 606 that can be accommodated in the constrained environment of the RFID tag 602 to allow both convenient and high-level security encryption/decryption.

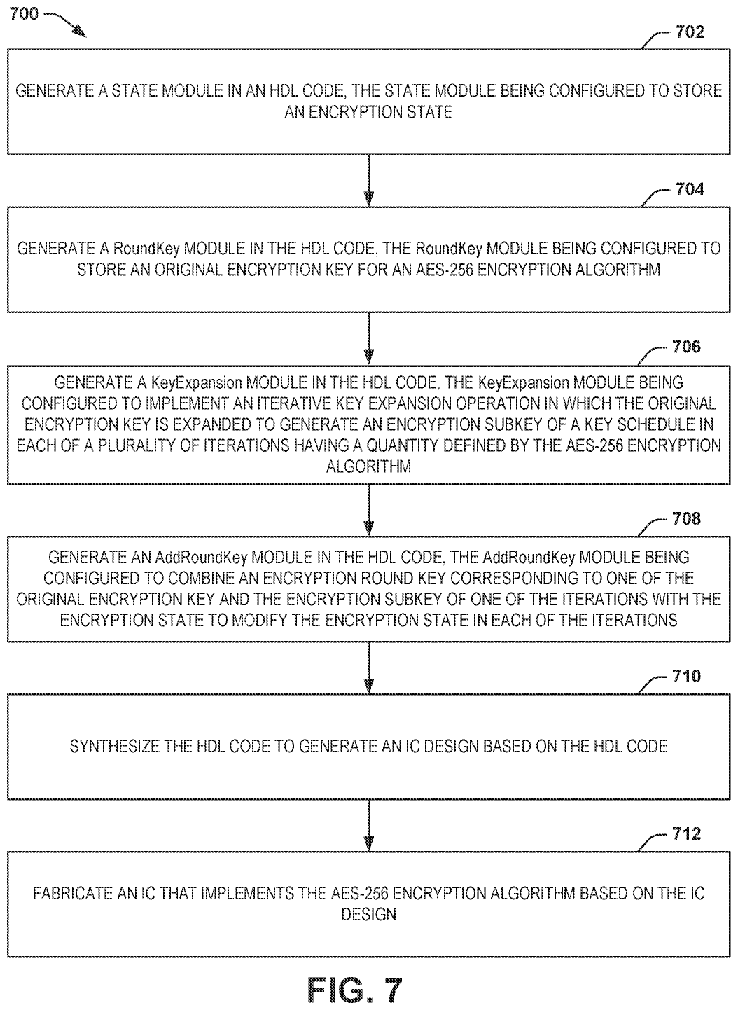

In view of the foregoing structural and functional features described above, a methodology in accordance with various aspects of the disclosure will be better appreciated with reference to FIG. 7. It is to be understood and appreciated that the method of FIG. 7 is not limited by the illustrated order, as some aspects could, in accordance with the present disclosure, occur in different orders and/or concurrently with other aspects from that shown and described herein. Moreover, not all illustrated features may be required to implement a methodology in accordance with an aspect of the present examples.

FIG. 7 illustrates an example of a method 700 for fabricating an IC (e.g., the IC 102). At 702, a State module (e.g., the State module 202) is generated in an HDL code (e.g., Verilog). The State module can be configured to store an encryption state (e.g., the encryption state 204). At 704, a RoundKey module (e.g., the RoundKey module 212) is generated in the HDL code. The RoundKey module can be configured to store an original encryption key (e.g., the original encryption key 218) for an AES-256 encryption algorithm (e.g., the AES-256 encryption algorithm 200). At 706, a KeyExpansion module (e.g., the KeyExpansion module 214) is generated in the HDL code. The KeyExpansion module can be configured to implement an iterative key expansion operation (e.g., the iterative key expansion operation 416) in which the original encryption key is expanded to generate an encryption subkey of a key schedule in each of a plurality of iterations having a quantity defined by the AES-256 encryption algorithm. At 708, an AddRoundKey module (e.g., the AddRoundKey module 216) is generated in the HDL code. The AddRoundKey module can be configured to combine an encryption round key corresponding to one of the original encryption key and the encryption subkey of one of the iterations with the encryption state to modify the encryption state in each of the iterations. At 710, the HDL code is synthesized to generate an IC design based on the HDL code. At 712, an IC that implements the AES-256 encryption algorithm is fabricated based on the IC design.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A security device system comprising:
a constrained environment housing;
operational components configured to implement a security function; and
an integrated circuit (IC) configured to implement a 256-bit Advanced Encryption Standard (AES-256) encryption algorithm, the IC comprising fewer than 5,000 gate equivalents and operating at a power of less than 1.5 microwatts to be accommodated in the constrained environment housing.

2. The system of claim 1, wherein the IC comprises:
a State module configured to store an encryption state;
a RoundKey module configured to store an original encryption key;
a KeyExpansion module configured to implement an iterative key expansion operation in which the original encryption key is expanded to generate an encryption subkey of a key schedule in each of a plurality of iterations; and
an AddRoundKey module configured to combine an encryption round key corresponding to one of the original encryption key and the encryption subkey of one of the iterations with the encryption state to modify the encryption state in each of the iterations.

3. The system of claim 2, wherein the RoundKey module comprises a key register, wherein the RoundKey module is configured to store the encryption subkey in the key schedule in the key register in each of the iterations and to overwrite the encryption subkey stored in the key register in a preceding one of the iterations.

4. The system of claim 3, wherein the KeyExpansion module is configured to load a last encryption subkey of the key schedule into the key register as an initial decryption key during a decryption procedure, wherein the KeyExpansion module is further configured to implement a reverse iterative key expansion operation comprising a reverse key expansion of the initial decryption key to generate a decryption subkey in a reverse key schedule in each of a plurality of decryption iterations during the decryption procedure, wherein the RoundKey module is configured to store the decryption subkey in the reverse key schedule in the key register in each of the decryption iterations and to overwrite the decryption subkey stored in the key register in the preceding one of the decryption iterations.

5. The system of claim 4, wherein the reverse key expansion concludes the reverse key expansion with the original encryption key after a last one of the iterations.

6. The system of claim 2, wherein the original encryption key comprises a first portion having a defined bit-length and a second portion having the defined bit-length, wherein the KeyExpansion module is configured to generate a first encryption subkey based on the first portion of the original encryption key in a first iteration, to generate a second encryption subkey based on the second portion of the original encryption key in a second iteration, and to generate each other encryption subkey based on an encryption subkey from a preceding iteration, the encryption subkey of each of the iterations having the defined bit-length.

7. The system of claim 6, wherein the AddRoundKey is configured to combine the first portion of the original encryption key with the encryption state to generate a first modified encryption state, to combine the second portion of the original encryption key with the first modified encryption state to generate a second modified encryption state, and to combine each encryption subkey of the key schedule with a subsequent modified encryption state in each respective one of thirteen iterations.

8. The system of claim 2, wherein the IC comprises a SubRows module, the SubRows module comprising a first S-box configured to implement a SubRows operation, wherein the first S-box comprises forward operation circuitry for encryption and inverse operation circuitry for decryption, wherein the KeyExpansion module comprises a second S-box configured to implement the iterative key expansion operation in each of the iterations, wherein the second S-box comprises only forward operation circuitry.

9. The system of claim 1, wherein the IC comprises:
a State module configured to store an encryption state; and
a MixColumn module comprising a MixColumn operational circuit that is configured to perform a MixColumn operation of the encryption state in both an encryption procedure and a decryption procedure, the MixColumn module further comprising an inverse enable circuit configured to toggle the MixColumn operational circuit between the encryption procedure and the decryption procedure.

10. The system of claim 1, wherein the security device system is configured as a radio frequency identification (RFID) tag.

11. A non-transitory computer readable medium comprising machine-readable instructions, the machine-readable instructions being executed to:
generate a State module in a hardware description language (HDL) code, the State module being configured to store an encryption state;
generate a RoundKey module in the HDL code, the RoundKey module being configured to store an original encryption key for a 256-bit Advanced Encryption Standard (AES-256) encryption algorithm;
generate a KeyExpansion module in the HDL code, the KeyExpansion module being configured to implement an iterative key expansion operation in which the original encryption key is expanded to generate an encryption subkey of a key schedule in each of a plurality of iterations having a quantity defined by the AES-256 encryption algorithm;
generate an AddRoundKey module in the HDL code, the AddRoundKey module being configured to combine an encryption round key corresponding to one of the original encryption key and the encryption subkey of one of the iterations with the encryption state to modify the encryption state in each of the iterations;
synthesize the HDL code to generate an integrated circuit (IC) design based on the HDL code; and
fabricate an IC that implements the AES-256 encryption algorithm based on the IC design.

12. The medium of claim 11, wherein the machine-readable instructions are further executed to generate a key register for the RoundKey module in the HDL code, wherein the RoundKey module is configured to store the encryption subkey in the key schedule in the key register in each of the iterations and to overwrite the encryption subkey stored in the key register in a preceding one of the iterations.

13. The medium of claim 11, wherein the machine-readable instructions are further executed to generate a SubRows module in the HDL code, the SubRows module comprising a first S-box configured to implement a SubRows operation, wherein the first S-box comprises forward operation circuitry for encryption and inverse operation circuitry for decryption, wherein the KeyExpansion module comprises a second S-box configured to implement the iterative key expansion operation in each of the iterations, wherein the second S-box comprises only forward operation circuitry.

14. The medium of claim 11, wherein the machine-readable instructions are further executed to generate a MixColumn module in the HDL code, the MixColumn module comprising a MixColumn operational circuit that is configured to perform a MixColumn operation of the encryption state in both an encryption procedure and a decryption procedure, the MixColumn module further comprising an inverse enable circuit configured to toggle the MixColumn operational circuit between the encryption procedure and the decryption procedure.

15. The medium of claim 11, wherein the IC is configured as one of an application specific integrated circuit (ASIC) or a field programmable gate array (FPGA) comprising fewer than 5,000 gate equivalents and operating at a power of less than 1.5 microwatts to be accommodated in a constrained environment.

16. A radio frequency identification (RFID) tag system comprising:
a transponder configured to wirelessly communicate with an RFID reader via wireless signals;
a memory configured to store sensitive data; and
an integrated circuit (IC) configured to implement a 256-bit Advanced Encryption Standard (AES-256) encryption algorithm configured to encrypt the sensitive data.

17. The system of claim 16, wherein the IC comprises:
a State module configured to store an encryption state; and
a MixColumn module comprising a MixColumn operational circuit that is configured to perform a MixColumn operation of the encryption state in both an encryption procedure and a decryption procedure, the MixColumn module further comprising an inverse enable circuit configured to toggle the MixColumn operational circuit between the encryption procedure and the decryption procedure.

18. The system of claim 16, wherein the IC comprises:
a State module configured to store an encryption state;
a RoundKey module configured to store an original encryption key;
a KeyExpansion module configured to implement an iterative key expansion operation in which the original encryption key is expanded to generate an encryption subkey of a key schedule in each of a plurality of iterations; and
an AddRoundKey module configured to combine an encryption round key corresponding to one of the original encryption key and the encryption subkey of one of the iterations with the encryption state to modify the encryption state in each of the iterations.

19. The system of claim 18, wherein the RoundKey module comprises a key register, wherein the RoundKey module is configured to store the encryption subkey in the key schedule in the key register in each of the iterations and to overwrite the encryption subkey stored in the key register in a preceding one of the iterations.

20. The system of claim 18, wherein the IC comprises a SubRows module, the SubRows module comprising a first S-box configured to implement a SubRows operation, wherein the first S-box comprises forward operation circuitry for encryption and inverse operation circuitry for decryption, wherein the KeyExpansion module comprises a second S-box configured to implement the iterative key expansion operation in each of the iterations, wherein the second S-box comprises only forward operation circuitry.
